(19) United States
(12) Patent Application Publication
(10) Pub. No.: US 2026/0320403 A1
(43) Pub. Date: Oct. 15, 2026

(54) UNSUPERVISED LANGUAGE MODEL PROMPT OPTIMIZATION FOR COMPLEX TASK RESOLUTION

(71) Applicant: Microsoft Technology Licensing, LLC, Redmond, WA (US)

(72) Inventors: Xiaowen WANG, Redmond, WA (US); Niraj Saranadhar Khanchandani, Kirkland, WA (US); Yaar Harari, Woodinville, WA (US); Eli Kravez, Bellevue, WA (US); Mohammad Khaled Alqudah, Everett, WA (US); Yingsi Jian, Jersey City, NJ (US); Yingqi Xiong, Plano, TX (US); Jiban Krishna Adhikary, Mountlake Terrace, WA (US)

(21) Appl. No.: 19/220,956

(22) Filed: May 28, 2025

Related U.S. Application Data
(60) Provisional application No. 63/786,822, filed on Apr. 10, 2025.

(51) Int. Cl. G06N 3/092; G06N 3/0475

(52) U.S. Cl. CPC G06N 3/092; G06N 3/0475

(57) ABSTRACT

Techniques and systems are disclosed to perform language model prompt optimization for complex task resolution, such as for natural language prompts used with large language models (LLMs). An example method includes: forming different combinations of subtasks that accomplish some overall task; generating corresponding combinations of subprompts; producing a performance prediction of combinations of subprompts to accomplish the overall task using the language model; evaluating the performance predictions against a threshold performance condition; selecting a combination for performing the overall task that meets the threshold performance condition; executing the subprompts corresponding to the selected combination of subtasks using the language model to accomplish the overall task; and outputting a response based on a result of the executing of the subprompts.

### PRIORITY CLAIM

This application claims the benefit of priority to U.S. Provisional Patent Application No. 63/786,822, filed Apr. 10, 2025, and titled “UNSUPERVISED LANGUAGE MODEL PROMPT OPTIMIZATION FOR COMPLEX TASK RESOLUTION”, which is incorporated herein by reference in its entirety.

### BACKGROUND

Generative AI language models such as Large Language Models (LLMs) are used to process and generate text and other content formats for a wide variety of applications and use cases. In particular, LLMs have shown usefulness in contexts where high volumes of data and complex tasks are involved, such as in connection with content summarization, automated communications, or real-time dialogue interpretation.

Multi-step prompts may be used with LLMs to handle complex tasks that require detailed and nuanced processing. For example, separate prompts may be used to break down intricate and complex tasks into manageable segments, allowing the LLM to sequentially use a series of directives to handle and verify specific aspects of the overall task.

Optimizing multi-step prompts for LLMs presents unique challenges, especially when dealing with complex tasks that involve detailed and nuanced requirements across diverse domains. For instance, consider a use case of an LLM that is prompted to summarize a lengthy real-time meeting transcript. The objective of summarization extends beyond simple conversation condensation because this objective involves fulfilling multiple intricate criteria, such as identifying and categorizing discussion topics, assessing potential risks, analyzing each topic's status, accurately extracting timestamps, and collating relevant hyperlinks or related content from the dialogue. Thus, the resulting multi-step prompt that is needed to correctly perform the overall task and objectives in an LLM may include complex instructions, directives, and detailed information.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts a multi-step configuration and optimization process for LLM prompt optimization, according to various examples of the present disclosure.

FIG. 2 depicts a data processing sequence for optimizing tasks used in LLM prompts, according to various examples of the present disclosure.

FIG. 3 depicts a single-step optimization process used in LLM prompt optimization, according to various examples of the present disclosure.

FIG. 4 depicts an operational data flow for generating and optimizing a multi-step LLM prompt, according to various examples of the present disclosure.

FIG. 5 depicts a flowchart of a method performed by a computing system for automated language model prompt optimization, according to various examples of the present disclosure.

FIG. 6 is a block diagram illustrating an example of a machine upon which one or more embodiments may be implemented.

### DETAILED DESCRIPTION

Disclosed in various examples are methods, systems, devices, and associated operations and functionality that enable the generation and optimization of multi-step prompts for use with LLMs and similar implementations of generative artificial intelligence (AI) language models, multimodal models, and trained content output models. The following methods and systems specifically introduce mechanisms for adaptive and unsupervised multi-step prompt optimization for prompts used with LLMs. It will be understood that the use of the terms “LLM” or “large language model” is for illustrative purposes, because the following techniques are applicable to other generative language models that might not be considered as “large” in size or capabilities.

In some examples, the following methods and systems use a dual-feedback mechanism that combines LLM feedback with reinforcement learning (RL) reward scores to automate the improvement and refinement of LLM prompts that divide an overall task into a combination of subtasks. By integrating qualitative insights from verbatim feedback with quantitative optimization via RL rewards, many types of multi-step or multi-stage prompts can be developed to execute in the LLM with improved performance across various complex subtasks and overall tasks. The following methods and systems are thus enabled to produce LLM prompts and subprompts that will attain high-quality performance for multi-step, detail-oriented tasks, without the need for human-generated supervised training data or similar human oversight or correction.

The following outlines an unsupervised optimization methodology that uses techniques such as N-gram and semantic similarity analysis, variance measurement, iterative tuning, reinforcement learning, and automated evaluation metrics. By integrating qualitative insights from verbatim feedback with quantitative optimization via RL rewards, the following approaches can enhance LLM performance across many types of complex tasks. These approaches reduce manual (human) oversight while simultaneously improving accuracy, adaptability, and efficiency in task resolution across multiple domains.

Many intricate requirements often need to be balanced when developing prompts for LLMs, due to the complexity of tasks necessitating precise information extraction and synthesis from voluminous text data. Generating supervised training data for such tasks typically necessitates human evaluators—an approach that is both labor-intensive and prone to inaccuracies. This underscores the technical need for a fully automated, unsupervised approach capable of dynamically adjusting and optimizing prompts, to manage complex, multi-domain requirements efficiently and effectively.

Thus, a technical problem encountered in the relevant field is the development of accurate and optimized LLM prompts that are adapted to many types of information domains. Although some humans can manually write detailed LLM prompts based on human judgment and skill, existing approaches for manually crafting LLM prompts lack the flexibility to dynamically adjust and optimize prompts in response to changing task requirements. This can lead to execution inefficiencies, incomplete data outputs, or potential errors in task execution. The reliance on human involvement also limits the scalability of many implementations, making them less suitable for applications that demand real-time results, high adaptability, or precision.

A technical solution provided by the approaches discussed herein includes automated improvement and execution for the generation and optimization of LLM prompts, which in turn can provide improvements in the data processing or execution of the LLM itself and associated efficiencies in computational operations for AI models and model execution. This automated improvement and execution can include an evaluation of the performance of different numbers of subtasks and subprompts, and the tuning of the prompts used by the subtasks and subprompts. Overall, the optimized multi-step LLM prompts offer a strategic tool for improving LLM performance and speed in complex task resolution, and the present approaches can be integrated into a variety of computational workflows to improve the ability of the models to deliver high-quality, accurate, and contextually appropriate outputs across diverse applications.

As non-limiting examples, certain domain-specific applications may invoke multi-step LLM prompts to improve accuracy and achieve improved results than those available with a single-step LLM prompt. For example, consider the data processing scenarios that might be used in the following domains, which would require or benefit from multi-stage LLM prompts:
A) Project Management: Use of an LLM for identifying the status of projects within extremely long conversations involves extracting key milestones, deadlines, and deliverables from discussions, providing insights into project progress, and highlighting any potential bottlenecks.
B) User Notifications: Use of an LLM for generating summaries of notifications for users based on their messages involves distilling essential information from extensive chat logs, and ensuring that notifications are timely, relevant, and personalized to enhance user experience.
C) Healthcare: Use of an LLM for summarizing patient and physician dialogues involves extracting key medical terms, assessing risk factors, identifying treatment options discussed, and providing a coherent continuation plan, while ensuring patient confidentiality and data privacy.
D) Legal: Use of an LLM for synthesizing large legal documents or case discussions involves identifying pertinent legal precedents, categorizing issues by statute or case relevance, and highlighting risks or contradictions while maintaining legal integrity and precision.
E) Customer Service: Use of an LLM for analyzing customer support interactions involves summarizing customer issues, categorizing queries by type or urgency, extracting sentiment or satisfaction levels, and logging actionable items to improve service response and quality.

The computational operations and performance of an LLM for these and other use cases can be improved using the following approaches.

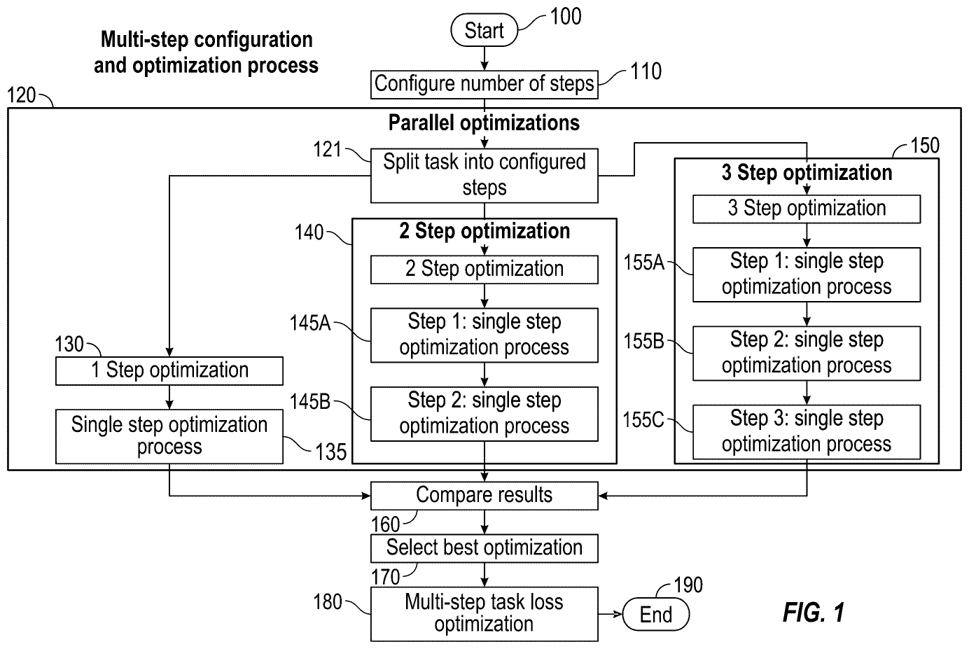

FIG. 1 depicts an example multi-step configuration and optimization process for LLM prompt optimization. First, the process starts at 100 and continues to a configuration 110 of the number of steps used for optimizations 120 of different variations of LLM prompts. The number of steps used for optimizations can be based on parallel or serial optimizations, with a fixed or dynamically evaluated number of steps. For example, a dynamically determined number of steps may involve serially generating additional different combinations of the steps, repeating until some threshold performance condition is met. A dynamically determined number of steps may also involve generating additional different combinations of the steps in parallel, and changing (e.g., increasing or decreasing) an optimal number of subtasks until some threshold performance condition is met.

The parallel optimizations 120 may be produced by splitting the overall task(s) to be performed in the LLM at 121, and forming different combinations of subtasks. Here, this involves dividing the task(s) into different combinations of separately configured subtasks, up to the configured number of steps specified at the configuration 110. For example, if the number of steps is three, then the parallel optimizations 120 will attempt one-step optimization, two-step optimization, and three-step optimization, where the number of steps corresponds to optimizations performed on separate steps, stages, or segments of an overall task (which are referred to as “sub-tasks”). As used herein, terms such as “step”, “stage”, or “segment” are used interchangeably, as they refer to a discrete action or unit-a subtask-within a larger overall task or process.

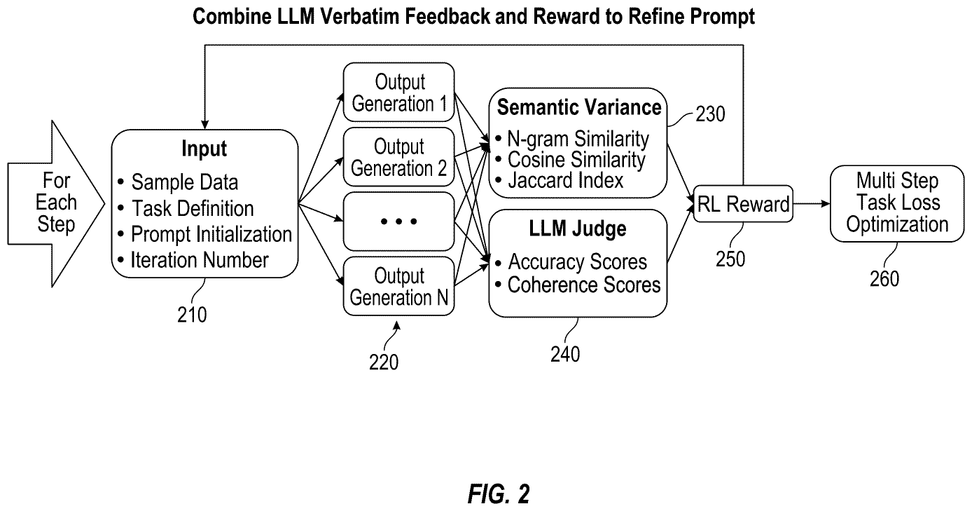

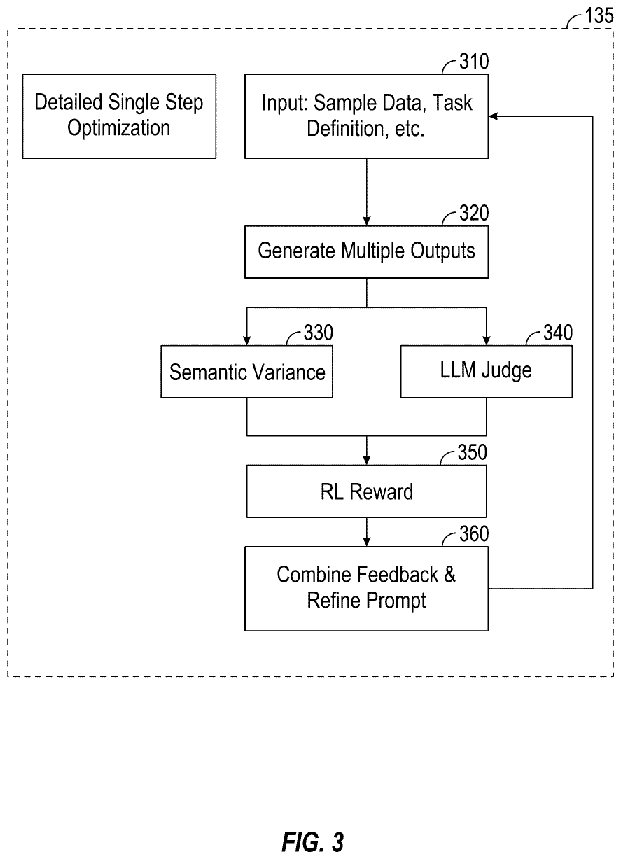

For instance, a first attempt of a one-step optimization 130 may include invoking one instance of a single-step optimization process 135 for the one step (one subtask) to perform an overall task with LLM prompt(s). A detailed breakdown of the data processing sequence for the single-step optimization process 135 is provided in FIG. 2, discussed below, and a data flow for the single-step optimization process 135 is provided in FIG. 3, also discussed below.

Additionally, a second attempt of a two-step optimization 140 may include invoking two instances of a single-step optimization process 145A, 145B, for the first step (first subtask) and the second step (second subtask) involved in the two-step LLM prompt. Likewise, a third attempt of a three-step optimization 150 may include invoking three instances of a single-step optimization process 155A, 155B, 155C, for the first step (first subtask), second step (second subtask), and third step (third subtask) involved in the three-step LLM prompt. The data processing sequence and data flow used in each instance of the single-step optimization process may also correspond to the sequence and flow depicted in FIGS. 2 and 3, discussed below.

The results of each of the 1-step, 2-step, and 3-step prompts are compared at 160, and a selection of the best optimization for the resulting prompts is performed at 170. The best optimization is then subjected to a multi-step task loss optimization at 180, and the process concludes at 190.

FIG. 2 depicts a data processing sequence for optimizing tasks used in LLM prompts. This data processing sequence depicts a breakdown of a single-step optimization process used in FIG. 1 (e.g., process 135, 145A, 145B, 155A, 155B, 155C), showing how an individual step used in a single-step or a multi-step LLM prompt sequence is refined.

FIG. 3 depicts additional operational detail of a single-step optimization process used in LLM prompt optimization. This flowchart also depicts a breakdown of the single-step optimization process used in FIG. 1 (e.g., process 135, 145A, 145B, 155A, 155B, 155C), showing how an individual step (e.g., an individual subtask) used in a single-step or a multi-step LLM prompt sequence is refined. FIGS. 2 and 3 are discussed together in the following paragraphs.

First, an input processing operation 310 occurs based on some received input 210. The input processing operation 310 may include task definition, prompt initialization, adaptability and flexibility definition, and iteration setup, as discussed in the following paragraphs.
Task Definition: The definition of a task in the input processing operation 310 may include defining a task scenario, such as summarizing complex meeting transcripts, long group chat conversations, generating user notifications from messages, or determining project status based on extensive discussions. Each task may require fulfilling several specific requirements, such as: a) Summarization: Condensing lengthy dialogues while retaining all critical points; b) Categorization: Identifying and organizing discussion topics into predefined categories (e.g., financial, strategic, operational); c) Risk Assessment: Highlighting potential risks discussed or inferred within the dialogue; d) Detail Extraction: Extracting specific details like timestamps or key figures; and e) Link Collation: Gathering relevant hyperlinks mentioned during the meeting narrative.
Prompt Initialization: The prompt initialization in the input processing operation 310 may include developing a base prompt that can be adapted for the complexity and specificity of the defined tasks. This foundational initial prompt serves as the starting point for iterative refinement and optimization during the approach. For example, consider the following example Prompt Setup as an example base prompt for conversation analysis:

TABLE 1
Please summarize the following group chat. Include main topics discussed,
key contributions, overall sentiment and any important links shared.
Maintain the chronological flow of the conversation.

Adaptability and Flexibility: The adaptability and flexibility definition in the input processing operation 310 may include defining the prompt's adaptability and flexibility using specified features or metrics that assess its capability to adjust across different task demands, such as: a) Task Versatility: measuring how well the prompt can shift focus between single-step tasks (basic summaries) and multi-step tasks (detailed analyses) without significant reengineering; b) Contextual Sensitivity: evaluating the prompt's ability to maintain context across diverse conversational styles and vocabularies without losing coherence or intent; and c) Dynamic Scaling: assessing the extent to which the prompt can accommodate varying levels of task complexity, from simple data extraction to in-depth thematic analyses.
Iteration Setup: The iteration setup in input processing operation 310 determines the optimal number of iterations N to thoroughly evaluate and refine outputs, balancing coverage and computational efficiency. An example strategy, for example, might include defining an iteration number, using N=10 as an example for ten iterations. This initial number can be tuned to ensure the model can generate a variety of summarizations, allowing for the assessment of consistency, diversity, and accuracy across outputs.

Next, an output generation operation 320 generates outputs 220 through N iterations of the LLM prompt execution. These outputs form the basis for detailed lexical and semantic analyses. Using 10 iterations as an example, the LLM explores multiple potential summaries, enabling analysts to capture consistent themes, topics, and sentiments. This process identifies variations in how the LLM processes nuances in the chat data, facilitating iterative refinement.

Next, similarity and variance analysis are performed via semantic variance evaluation operation 330 and LLM evaluation operation 340. In these respective operations, semantic variance data 230 (such as similarity data) and LLM scoring data 240 (such as accuracy and coherence scores) are evaluated.

In a first example, the semantic variance evaluation operation 330 may include lexical and semantic measurement based on N-gram similarity. This evaluates the lexical consistency across multiple outputs by analyzing multi-length n-grams (e.g., unigram, bigram, trigram). For a given output XXX, let GXG_XGX denote the multiset of its n-grams. A common measure to quantify similarity between two outputs XXX and YYY is the n-gram overlap, which can be expressed using a Jaccard-like formulation:

$$NgramSimilarity ( X , Y ) = \frac{\vert GX ⋂ GY \vert}{\vert GX ⋃ GY \vert}$$

Alternatively, when frequency information is important, one can represent each output as a vector of n-gram counts and compute the cosine similarity between these vectors. This helps in identifying recurring patterns and frequency variations, ensuring that essential lexical elements of the dialogue are consistently maintained.

In a second example, the semantic variance evaluation operation 330 may include lexical and semantic measurement based on Semantic Similarity Measures, such as cosine similarity or a Jaccard index.

Cosine Similarity: This measure quantifies similarity between two vector representations by computing the cosine of the angle between them. For embeddings A and B, it is defined as:

$$CosineSimilarity ( A , B ) = \frac{A \cdot B}{‖ A ‖ ‖ B ‖}$$

While widely used, cosine similarity should be complemented with other metrics to capture nuanced semantic differences in multidimensional spaces. Given that GPT-based embeddings are predominantly used, incorporating models like BERT or Sentence Transformers—which offer context-rich, bidirectional insights—can further enhance semantic evaluation.

A Jaccard index is a measure of similarity between two sets, defined as the ratio of the size of their intersection to the size of their union. For two sets A and B, it is given by:

$$J ( A , B ) = \frac{\vert A ∩ B \vert}{\vert A ⋃ B \vert}$$

In the context of lexical analysis, the sets can represent key terms, n-grams, or extracted features from the outputs. This metric helps evaluate the overlap and diversity in lexical content.

In a third example, the semantic variance evaluation operation 330 may also perform other forms of variance measurement. For instance, a combined approach using the variance of n-gram-based lexical similarities and embedding-based semantic similarities can provide insights into how consistent the outputs are across different dialects and styles.

The following example formulation for variance measurement assigns equal weight to each similarity metric as follows.

$$Variance = \frac{1}{( \begin{matrix}n \\ 2\end{matrix} )} {\sum }_{i = 1}^{N - 1} {\sum }_{j = i + 1}^{N} [ \frac{1}{3} * CosineDistance ( {embedding}_{i} , {embedding}_{j} ) + \frac{1}{3} * NgramDistance ( {X}_{i} , {X}_{j} ) + \frac{1}{3} * JaccardDistance ( {S}_{i} , {S}_{j} ) ]$$

Where CosineDistance, NgramDistance, and JaccardDistance are defined as discussed above.

Next, the LLM evaluation operation 340 may include aspects of diverse model evaluation. For instance, this may include evaluating LLM prompts produced from different LLM models based on LLM scoring data 240 such as accuracy scores and coherence scores, ensuring the robustness of assessments and reducing model-specific biases. Models selected should have an equivalent or superior performance to the target LLM. For example, to evaluate a GPT-4.0 Mini model while ensuring robustness and minimizing model-specific biases, the results from a diverse set of GPT models can be compared, such as GPT-4.0, GPT-4.5, and GPT-O1. Each of these models offers unique strengths and enhancements that make them suitable evaluators.

Next, reinforcement learning integration is obtained using RL reward operation 350 which produces a RL reward 250. The RL reward operation may include an adaptive strategy implementation that uses reinforcement learning frameworks to dynamically adjust and refine prompts. For instance, this may implement an RL loop where the model continuously generates outputs in response to prompts, as the RL loop includes mechanisms for real-time feedback collection. Through this approach, prompts can be adjusted iteratively based on the outcomes of generated responses, encouraging improvement in task-specific performance.

The RL reward function may incorporate a reward function that aligns with the goals of the task. This may involve aspects such as accuracy of information, coherence of response, completion of specific tasks, or adherence to style guidelines. The reward function should incentivize these goals, effectively directing the model toward desired behaviors. An example reward function used in RL reward operation 350 may include:

$$Reward = {η}_{1} * Accuracy Score + {η}_{2} * Coherence Score - {η}_{3} * Variance - {η}_{4} * Penalty$$

Where Penalty is structured similarly to a regularization term that penalizes high variance or failure in high-priority tasks.

Additionally, the RL reward operation 350 may include aspects of strategic optimization, to apply policy gradient methods or Q-learning for ongoing adaptive prompt optimization based on real-time feedback from an LLM judge.

Next, a feedback and refinement operation 360 is used to combine feedback and refine the prompt. This operation can provide a dynamic loss function and optimization that is used to combine the RL reward 250 and LLM verbatim feedback to provide changes to the input 210. An example loss formulation may use a dynamic loss function as follows:

$$loss = f ( \begin{matrix}semantic variance , semantic accuracy score , \\ output coherence score\end{matrix} )$$

This dynamic loss function can be adjusted according to the task's specific requirements. Here, semantic variance is presented across outputs while maintaining relevance. The semantic accuracy score is the precision and retention of the intended meaning in the original data source. The output coherence score measures the consistency and flow of the narrative, maintaining a logical progression.

Based on this feedback, an iterative feedback loop (from the RL reward 250 to the input 210) can be established based on: a) convergence criteria, which sets stopping criteria with convergence metrics to avoid unnecessary computation; and b) gradient descent application, which uses gradient descent to iteratively refine the prompt, targeting the minimization of loss.

Additional optimization can be performed based on multi-step task loss optimization 260, to determine the best optimization based on different numbers of steps (e.g., for determining an optimal combination of subtasks with corresponding subprompts, as discussed with reference to operations 160, 170, 180 in FIG. 1).

Further aspects of evaluation and monitoring can be used to evaluate the generated prompts. One example of evaluation and monitoring may include automated Metrics Integration, such as by using ROUGE and BLEU scores within the evaluation process. Continuous Quality Assessment also can be used to assimilate these metrics into an optimization process to ensure continuous quality output checks. ROUGE (Recall-Oriented Understudy for Gisting Evaluation) is a set of metrics that can be applied to compare generated information against reference information. ROUGE can provide a measurement of recall, to measure the recall of crucial information in output summaries. BLEU (BiLingual Evaluation Understudy) is a metric for evaluating the quality of text, such as text that has been translated from one language to another. BLEU can provide a measurement of precision to compare the precision of n-grams between generated outputs and their references.

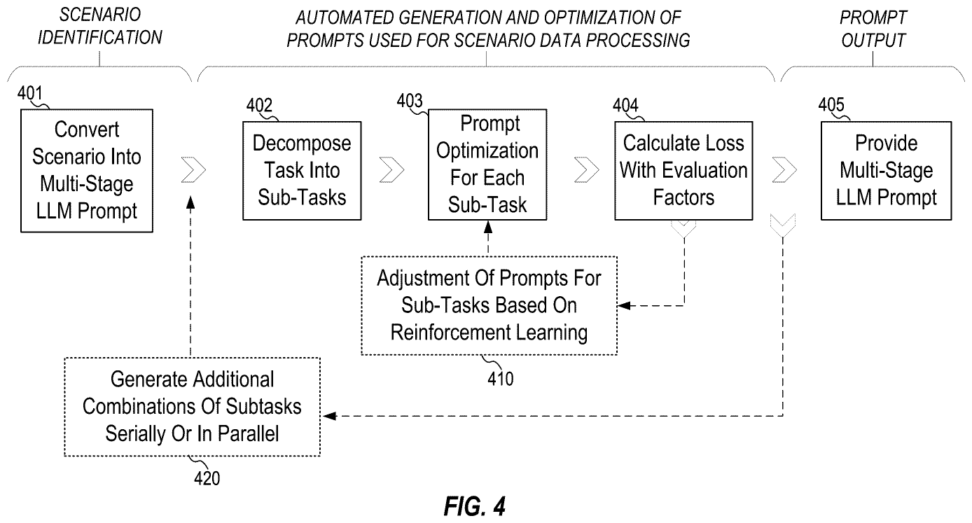

FIG. 4 depicts an operational data flow for generating and optimizing a multi-step LLM prompt, providing an implementation example of the techniques discussed above.

First, at operation 401, a scenario is converted into a multi-stage LLM prompt sequence. Consider a scenario involving analysis and summarization of text and content from an extended project briefing, including topic categorization, risk identification, and links and timeline extraction.

Operations 402, 403, and 404 perform Iterative Step Evaluation. For N different combinations, ranging from 1 to a configured maximum N, the following operations 402, 403, 404, 410 are repeated. For example, this may be based on generating additional combinations of subtasks at operation 420 that increase N with serial or parallel evaluation of the combinations of subtasks, until some threshold performance condition is met.

First, at operation 402, initial attempts are performed with the language model to determine how to decompose the task into some number of subtasks, up to N steps. This may start with simpler tasks like overall summarization (one-step) and may progress to more detailed sub-tasks (multiple steps), such as: 1) identify key topics; 2) perform risk assessment; 3) extract key links; 4) compile a timeline of events.

Next, at operation 403, optimization is performed for each sub-task. Each step is optimized individually to ensure it effectively contributes to the overall task. This involves using prompt refinement and task-specific tuning to enhance each segment's accuracy and relevance, such as was described for FIGS. 3 and 4.

Next, at operation 404, a reinforcement learning loss is calculated based on several factors such as: number of steps, semantic variance of candidate sub-prompts, or judgment scores from different candidate subprompts. Different candidate subprompts may be evaluated until one of the candidate subprompts is selected as an optimized subprompt for a particular subtask.

In particular, with operations 402, 403, and 404, reinforcement learning integration is performed at 410 to adjust the prompts for the various subtasks. This may be implemented in an RL agent that monitors the performance metrics and iteratively adjusts the different combinations of subtasks and the prompts used for these subtasks. The RL agent receives feedback based on the calculated loss, guiding experimentation with different step configurations. Over time, the RL agent learns the optimal balance between task granularity and execution efficiency, adapting the task breakdown to maximize output quality while minimizing unnecessary complexity.

At operation 405, a multi-stage LLM prompt output is produced. Accordingly, the unsupervised optimization strategy discussed herein offers a comprehensive and efficient approach to refining LLM prompts for complex task resolution. By integrating advanced techniques such as reinforcement learning, semantic analysis, and dynamic loss functions, this framework addresses the multifaceted challenges inherent in task-specific prompt optimization.

These approaches significantly reduce dependency on human-generated training data, thus streamlining the prompt optimization process. The framework's ability to dynamically refine prompts across diverse domains—be it summarizing intricate meeting transcripts, identifying legal precedents, or enhancing customer service interactions—demonstrates its versatility and robustness. As a result, LLMs can handle sophisticated, multi-step tasks with greater precision and coherence, improving the quality and relevance of outputs.

Continuous evaluation through metrics such as ROUGE and BLEU scores can provide an automated approach to verify adaptation not only to varying task complexities but also to provide a high standard of output quality. Accordingly, these approaches hold promise for numerous applications, enabling more efficient project management, customized user interactions, and comprehensive legal analyses, among others, without the need for exhaustive human oversight.

Future extensions of these approaches may include further enhancing model adaptability, expanding the range of tasks LLMs can tackle autonomously, and improving the scalability of the solution across even more complex and varied data sets. Overall, the unsupervised optimization strategy provides a significant advantage in augmenting the functional capacity of LLMs, enabling more intelligent and autonomous computational systems.

As will be understood, the unsupervised learning framework discussed above can be fully or partially automated to produce, select, and optimize LLM prompts for invoking complex tasks in a variety of project domains. This unsupervised learning framework can be automated or semi-automated to eliminate the reliance on human oversight and human-generated supervised training data, thereby minimizing manual effort while maximizing the accuracy, efficiency, and adaptability of task execution.

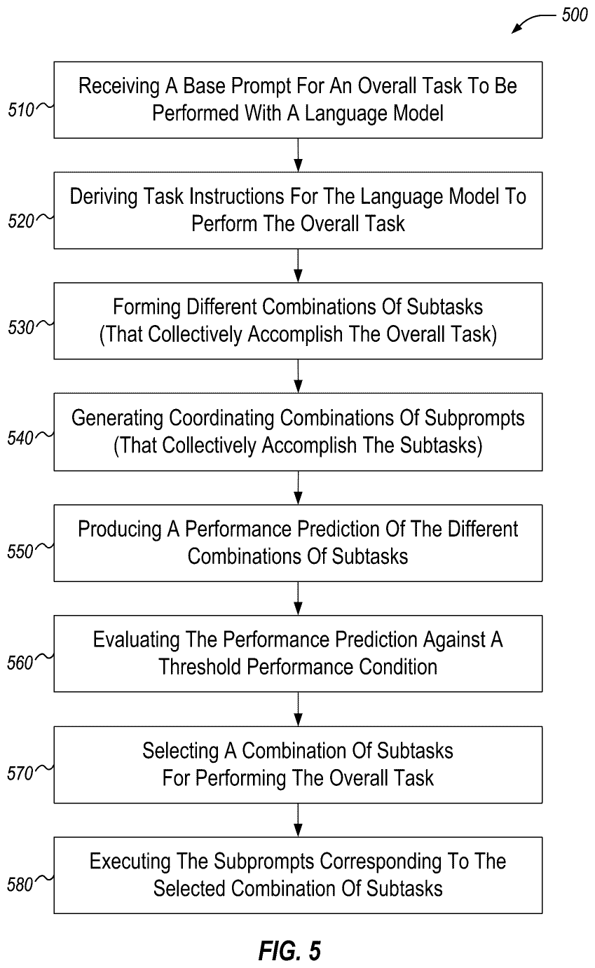

FIG. 5 depicts a flowchart 500 of a method performed by a computing system for automated language model prompt optimization, including generating and optimizing subprompts for subtasks of an overall task to be performed with a language model. In particular, the flowchart 500 presents a method that can use unsupervised optimization techniques to effectively refine individual portions of LLM prompt sequences. This approach can integrate a variety of reinforcement learning and automated evaluation approaches for refinement of the prompts and subprompts, as discussed above.

At operation 510, the flowchart 500 begins by receiving a base prompt for an overall task to be performed with a language model. In some examples, the base prompt may be accompanied by input data such as sample data and a task definition used for guiding the prompt optimization process. In other examples, sample data that is associated with task definition and the overall task may be generated.

At operation 520, the flowchart 500 continues with deriving task instructions for the language model to perform the overall task, based on the base prompt and optionally the input data. Such task instructions may be based on a task definition as discussed above with reference to FIG. 2.

At operation 530, the flowchart 500 continues with forming multiple different combinations of subtasks, based on the task instructions. In this context, each of the different combinations of subtasks provides a different number of subtasks that, if performed collectively, accomplish the overall task. This may provide an implementation of operation 121 in FIG. 1, discussed above.

At operation 540, the flowchart 500 continues with generating a combination of subprompts for each of the different combinations of subtasks. This produces a combination of subprompts that, if performed by (e.g., executed by) the language model, collectively accomplish that combination of subtasks. This may provide an implementation of operations 130, 140, and 150 in FIG. 1, discussed above.

At operation 550, the flowchart 500 continues with producing a performance prediction of that combination to accomplish the overall task using the language model, for each of the different combinations of subtasks. In some examples, the performance prediction may be based on optimization metrics produced from individual subtasks and subprompts, as discussed above with FIG. 3, including from an evaluation on sample data. In other examples, the performance prediction may be based on other system measurements or estimations, including from an evaluation by a learned (trained) model.

At operation 560, the flowchart 500 continues with evaluating the performance prediction of each of the different combinations of subtasks against at least one threshold performance condition. In one example, the threshold performance condition is based on a prediction of execution time, cost, or performance, and the prediction is produced from evaluating the subprompts for the different combinations of subtasks with a learned model. In another example, the threshold performance condition is based on accuracy or coherence of results produced from the subprompts for the different combinations of subtasks, where the evaluated results are produced from trial runs that execute the subprompts on sample data.

At operation 570, the flowchart 500 continues with selecting one combination from the different combinations of subtasks for performing the overall task. In one example, the selected combination has a performance prediction meeting (or exceeding) the threshold performance condition, and has a lowest number of subtasks among all combinations having respective performance predictions meeting the threshold performance condition. Other techniques may be used for selecting the particular combination of subtasks for performing the overall task.

At operation 580, the flowchart 500 continues with executing the subprompts that correspond to the selected combination of subtasks, using the language model and data associated with the base prompt (e.g., input data), in an effort to accomplish the overall task.

Further operations (not shown) may include outputting a response to the base prompt, based on a result of the executing of the subprompts. A variety of other computer-implemented actions, functions, or operations may be caused as a result of the executing of the subprompts.

Another operation (not depicted) may include generating sample data, such as sample data used for evaluating the performance prediction at operation 560. The sample data may be generated based on some relationship or association with the overall task.

Another operation (not depicted) may include repeating some or all of operations of flowchart 500, using a plurality of LLMs. This may include scenarios where different combinations of subprompts are produced and/or executed with different models. In this context, the performance of the resulting combination of optimized subprompts can be compared relative to multiple types or versions of LLMs.

As discussed above, the techniques of operation 540 for generating the corresponding combination of the subprompts can include iteratively generating optimized subprompts that accomplish the different combinations of subtasks, using a reinforcement learning technique. The use of a reinforcement learning technique can iteratively improve and produce subprompts used by each of the combinations of subprompts.

In a specific example, iteratively generating the optimized subprompts, for a respective subtask of the different combinations of subtasks, includes:
(i) generating multiple different candidate subprompts for the respective subtask, wherein each candidate subprompt includes varying subtask instructions to control the language model to perform the respective subtask;
(ii) executing the multiple different candidate subprompts in the language model to generate corresponding multiple evaluation results for the respective subtask;
(iii) measuring semantic variance, accuracy, and coherence of the multiple evaluation results using at least one natural language processing technique;
(iv) determining a reinforcement learning reward for each candidate subprompt of the multiple different candidate subprompts, based on the semantic variance, accuracy, and coherency measured for a respective result produced from the candidate subprompt;
(v) refining the multiple different candidate subprompts based on the reinforcement learning reward determined for each candidate subprompt; and
(vi) selecting one of the multiple different candidate subprompts as an optimized subprompt for the respective subtask.

Other sequences may be used. In a specific example, measuring the semantic variance includes producing a semantic variance score from an evaluation of at least one of: (a) a n-gram similarity that measures similarity between n-grams of two outputs; (b) cosine similarity that measures similarity between two embeddings; or (c) a Jaccard index that measures similarity between terms, n-grams, or features of two sets. Also in a specific example, measuring the accuracy includes producing a semantic precision score of a corresponding evaluation result, and wherein measuring the coherency includes producing a coherence score of the corresponding evaluation result.

In such settings, the reinforcement learning reward is produced from a loss function that uses the semantic variance score, the semantic precision score, and the coherence score for each respective candidate subprompt. Gradient descent is also applied to iteratively refine each respective candidate subprompt to target loss minimization.

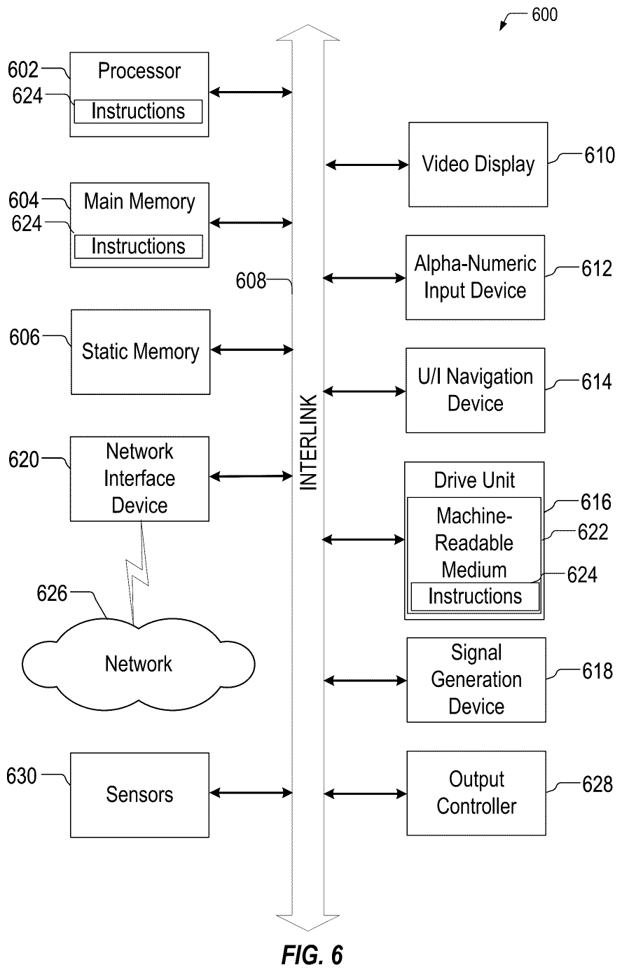

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a computing device such as a personal computer (PC), a tablet PC, a personal digital assistant (PDA), a mobile telephone, a cloud-based or networked server, a virtualized server, a smart phone, a web appliance, a network router, an access point, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 600 specifically may implement the devices and platforms used to implement the operations depicted in FIGS. 1-5, or any of the servers, devices, or computing elements referenced herein.

Examples, as described herein, may include, or may operate on, logic or a number of components, modules, or mechanisms (hereinafter “components”). Such components are tangible entities (e.g., hardware) capable of performing specified operations and may be configured or arranged in a certain manner. In an example, circuits or circuitry may be arranged (e.g., internally or with respect to external entities such as other circuits or circuitry) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium, such as a non-transitory machine-readable storage medium. In an example, the software, when executed by the underlying hardware of the component, causes the hardware to perform the specified operations.

Accordingly, such a component encompasses a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 630, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, a machine-readable medium may include a single medium or multiple media (e.g., a centralized or distributed database, and/or associated caches and servers) configured to store the one or more instructions 624. Thus, the term machine readable medium may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions.

Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media (e.g., excluding a transitory propagating signal).

The instructions 624 may further be transmitted or received over a communications network 626 using a transmission medium via the network interface device 620. The machine 600 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), satellite communication networks, and wireless data networks, such as networks implementing the Institute of Electrical and Electronics Engineers (IEEE) 802.11 family of standards known as Wi-Fi®, a 5G or 4G/Long Term Evolution (LTE) family of standards, satellite communication networks, peer-to-peer (P2P) networks, among others. In an example, the network interface device 620 may include one or more physical interfaces (e.g., Ethernet, coaxial, or optical interfaces) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a method for automated language model prompt optimization, comprising: receiving a base prompt for an overall task to be performed with a language model; based on the base prompt, deriving task instructions for the language model to perform the overall task; based on the task instructions, forming multiple different combinations of subtasks, wherein each of the different combinations of subtasks provides a different number of subtasks that, if performed collectively, accomplish the overall task; for each of the different combinations of subtasks, generating a corresponding combination of subprompts that, if performed by the language model, collectively accomplish that combination of subtasks; for each of the different combinations of subtasks, producing a performance prediction of that combination to accomplish the overall task using the language model, according to the corresponding combination of the subprompts; evaluating the performance prediction of each of the different combinations of subtasks against a threshold performance condition; selecting one combination from the different combinations of subtasks for performing the overall task, wherein the selected combination has a performance prediction meeting the threshold performance condition, and has a lowest number of subtasks among all combinations having respective performance predictions meeting the threshold performance condition; executing the subprompts corresponding to the selected combination of subtasks using the language model and data associated with the base prompt, to accomplish the overall task; and outputting a response to the base prompt based on a result of the executing of the subprompts.

In Example 2, the subject matter of Example 1 optionally includes wherein the method includes serially generating additional different combinations of subtasks, generating subprompts used by the additional different combinations of subtasks, and evaluating a performance prediction of the additional different combinations of subtasks, until the threshold performance condition is met.

In Example 3, the subject matter of any one or more of Examples 1-2 optionally include wherein the method includes generating additional different combinations of subtasks, generating subprompts used by the additional different combinations of subtasks, and evaluating a performance prediction of the additional different combinations of subtasks, in parallel for the different number of subtasks, wherein a number of subtasks is changed until the threshold performance condition is met.

In Example 4, the subject matter of any one or more of Examples 1-3 optionally include wherein the threshold performance condition is based on a prediction of execution time, cost, or performance, and wherein the prediction is produced from evaluating the subprompts for the different combinations of subtasks with a learned model.

In Example 5, the subject matter of any one or more of Examples 1~4 optionally include wherein the threshold performance condition is based on accuracy or coherence of results produced from the subprompts for the different combinations of subtasks, and wherein the results are produced from trial runs that execute the subprompts on sample data.

In Example 6, the subject matter of Example 5 optionally includes generating the sample data, wherein the sample data is associated with the overall task; wherein the language model is a large language model (LLM), the method is repeated with use in a plurality of LLMs, and performance of the subprompts is compared based on use in the plurality of LLMs.

In Example 7, the subject matter of any one or more of Examples 1-6 optionally include wherein generating the corresponding combination of the subprompts includes iteratively generating optimized subprompts that accomplish the different combinations of subtasks, using a reinforcement learning technique, to improve and produce subprompts used by each of the combinations of subprompts.

In Example 8, the subject matter of Example 7 optionally includes wherein iteratively generating the optimized subprompts includes, for a respective subtask of the different combinations of subtasks: generating multiple different candidate subprompts for the respective subtask, wherein each candidate subprompt includes varying subtask instructions to control the language model to perform the respective subtask; executing the multiple different candidate subprompts in the language model to generate corresponding multiple evaluation results for the respective subtask; measuring semantic variance, accuracy, and coherence of the multiple evaluation results using at least one natural language processing technique; determining a reinforcement learning reward for each candidate subprompt of the multiple different candidate subprompts, based on the semantic variance, accuracy, and coherency measured for a respective result produced from the candidate subprompt; refining the multiple different candidate subprompts based on the reinforcement learning reward determined for each candidate subprompt; and selecting one of the multiple different candidate subprompts as an optimized subprompt for the respective subtask.

In Example 9, the subject matter of Example 8 optionally includes wherein measuring the semantic variance includes producing a semantic variance score from an evaluation of at least one of: a n-gram similarity that measures similarity between n-grams of two outputs; cosine similarity that measures similarity between two embeddings; or a Jaccard index that measures similarity between terms, n-grams, or features of two sets; and wherein measuring the accuracy includes producing a semantic precision score of a corresponding evaluation result, and wherein measuring the coherency includes producing a coherence score of the corresponding evaluation result.

In Example 10, the subject matter of Example 9 optionally includes wherein the reinforcement learning reward is produced from a loss function that uses the semantic variance score, the semantic precision score, and the coherence score for each respective candidate subprompt, and wherein gradient descent is applied to iteratively refine each respective candidate subprompt to target loss minimization.

Example 11 is a non-transitory machine-readable medium, storing instructions for automated language model prompt optimization, the instructions, which when executed, cause a machine to perform operations comprising: receiving a base prompt for an overall task to be performed with a language model; based on the base prompt, deriving task instructions for the language model to perform the overall task; based on the task instructions, forming multiple different combinations of subtasks, wherein each of the different combinations of subtasks provides a different number of subtasks that if performed collectively, accomplish the overall task; for each of the different combinations of subtasks, generating a corresponding combination of subprompts that, if performed by the language model, collectively accomplish that combination of subtasks; for each of the different combinations of subtasks, producing a performance prediction of that combination to accomplish the overall task using the language model, according to the corresponding combination of the subprompts; evaluating the performance prediction of each of the different combinations of subtasks against a threshold performance condition; selecting one combination from the different combinations of subtasks for performing the overall task, wherein the selected combination has a performance prediction meeting the threshold performance condition, and has a lowest number of subtasks among all combinations having respective performance predictions meeting the threshold performance condition; executing the subprompts corresponding to the selected combination of subtasks using the language model and data associated with the base prompt, to accomplish the overall task; and outputting a response to the base prompt based on a result of the executing of the subprompts.

In Example 12, the subject matter of Example 11 optionally includes wherein the operations comprise serially generating additional different combinations of subtasks, generating subprompts used by the additional different combinations of subtasks, and evaluating a performance prediction of the additional different combinations of subtasks, until the threshold performance condition is met.

In Example 13, the subject matter of any one or more of Examples 11-12 optionally include wherein the operations comprise generating additional different combinations of subtasks, generating subprompts used by the additional different combinations of subtasks, and evaluating a performance prediction of the additional different combinations of subtasks, in parallel for the different number of subtasks, wherein a number of subtasks is changed until the threshold performance condition is met.

In Example 14, the subject matter of any one or more of Examples 11-13 optionally include wherein the threshold performance condition is based on a prediction of execution time, cost, or performance, and wherein the prediction is produced from evaluating the subprompts for the different combinations of subtasks with a learned model.

In Example 15, the subject matter of any one or more of Examples 11-14 optionally include wherein the threshold performance condition is based on accuracy or coherence of results produced from the subprompts for the different combinations of subtasks, and wherein the results are produced from trial runs that execute the subprompts on sample data.

In Example 16, the subject matter of Example 15 optionally includes the operations further comprising: generating the sample data, wherein the sample data is associated with the overall task; wherein the language model is a large language model (LLM), the operations are repeated with use in a plurality of LLMs, and performance of the subprompts is compared based on use in the plurality of LLMs.

In Example 17, the subject matter of any one or more of Examples 11-16 optionally include wherein generating the corresponding combination of the subprompts includes iteratively generating optimized subprompts that accomplish the different combinations of subtasks, using a reinforcement learning technique, to improve and produce subprompts used by each of the combinations of subprompts.

In Example 18, the subject matter of Example 17 optionally includes wherein iteratively generating the optimized subprompts includes, for a respective subtask of the different combinations of subtasks: generating multiple different candidate subprompts for the respective subtask, wherein each candidate subprompt includes varying subtask instructions to control the language model to perform the respective subtask; executing the multiple different candidate subprompts in the language model to generate corresponding multiple evaluation results for the respective subtask; measuring semantic variance, accuracy, and coherence of the multiple evaluation results using at least one natural language processing technique; determining a reinforcement learning reward for each candidate subprompt of the multiple different candidate subprompts, based on the semantic variance, accuracy, and coherency measured for a respective result produced from the candidate subprompt; refining the multiple different candidate subprompts based on the reinforcement learning reward determined for each candidate subprompt; and selecting one of the multiple different candidate subprompts as an optimized subprompt for the respective subtask.

In Example 19, the subject matter of Example 18 optionally includes wherein measuring the semantic variance includes producing a semantic variance score from an evaluation of at least one of: a n-gram similarity that measures similarity between n-grams of two outputs; cosine similarity that measures similarity between two embeddings; or a Jaccard index that measures similarity between terms, n-grams, or features of two sets; and wherein measuring the accuracy includes producing a semantic precision score of a corresponding evaluation result, and wherein measuring the coherency includes producing a coherence score of the corresponding evaluation result.

In Example 20, the subject matter of Example 19 optionally includes wherein the reinforcement learning reward is produced from a loss function that uses the semantic variance score, the semantic precision score, and the coherence score for each respective candidate subprompt, and wherein gradient descent is applied to iteratively refine each respective candidate subprompt to target loss minimization.

Example 21 is a computing device adapted for automated language model prompt optimization, the computing device comprising: a network interface to receive data including a base prompt; at least one hardware processor; and at least one memory device, including instructions, which when executed, cause the hardware processor to: identify a command to perform an overall task with a language model; based on the base prompt, derive task instructions for the language model to perform the overall task; based on the task instructions, form multiple different combinations of subtasks, wherein each of the different combinations of subtasks provides a different number of subtasks that if performed collectively, accomplish the overall task; for each of the different combinations of subtasks, generate a corresponding combination of subprompts that, if performed by the language model, collectively accomplish that combination of subtasks; for each of the different combinations of subtasks, produce a performance prediction of that combination to accomplish the overall task using the language model, according to the corresponding combination of the subprompts; evaluate the performance prediction of each of the different combinations of subtasks against a threshold performance condition; select one combination from the different combinations of subtasks for performing the overall task, wherein the selected combination has a performance prediction meeting the threshold performance condition, and has a lowest number of subtasks among all combinations having respective performance predictions meeting the threshold performance condition; execute the subprompts corresponding to the selected combination of subtasks using the language model and data associated with the base prompt, to accomplish the overall task; and output a response to the base prompt based on a result of the executing of the subprompts.

In Example 22, the subject matter of Example 21 optionally includes wherein the instructions cause the hardware processor to serially generate additional different combinations of subtasks, generating subprompts used by the additional different combinations of subtasks, and evaluating a performance prediction of the additional different combinations of subtasks, until the threshold performance condition is met.

In Example 23, the subject matter of any one or more of Examples 21-22 optionally include wherein the instructions cause the hardware processor to generate additional different combinations of subtasks, generate subprompts used by the additional different combinations of subtasks, and evaluate a performance prediction of the additional different combinations of subtasks, in parallel for the different number of subtasks, wherein a number of subtasks is changed until the threshold performance condition is met.

In Example 24, the subject matter of any one or more of Examples 21-23 optionally include wherein the threshold performance condition is based on a prediction of execution time, cost, or performance, and wherein the prediction is produced from evaluating the subprompts for the different combinations of subtasks with a learned model.

In Example 25, the subject matter of any one or more of Examples 21-24 optionally include wherein the threshold performance condition is based on accuracy or coherence of results produced from the subprompts for the different combinations of subtasks, and wherein the results are produced from trial runs that execute the subprompts on sample data.

In Example 26, the subject matter of Example 25 optionally includes wherein the instructions cause the hardware processor to: generate the sample data, wherein the sample data is associated with the overall task; wherein the language model is a large language model (LLM), operations are repeated with use in a plurality of LLMs, and performance of the subprompts is compared based on use in the plurality of LLMs.

In Example 27, the subject matter of any one or more of Examples 21-26 optionally include wherein to generate the corresponding combination of the subprompts includes to iteratively generate optimized subprompts that accomplish the different combinations of subtasks, using a reinforcement learning technique, to improve and produce subprompts used by each of the combinations of subprompts.

In Example 28, the subject matter of Example 27 optionally includes wherein to iteratively generate the optimized subprompts includes, for a respective subtask of the different combinations of subtasks: generating multiple different candidate subprompts for the respective subtask, wherein each candidate subprompt includes varying subtask instructions to control the language model to perform the respective subtask; executing the multiple different candidate subprompts in the language model to generate corresponding multiple evaluation results for the respective subtask; measuring semantic variance, accuracy, and coherence of the multiple evaluation results using at least one natural language processing technique; determining a reinforcement learning reward for each candidate subprompt of the multiple different candidate subprompts, based on the semantic variance, accuracy, and coherency measured for a respective result produced from the candidate subprompt; refining the multiple different candidate subprompts based on the reinforcement learning reward determined for each candidate subprompt; and selecting one of the multiple different candidate subprompts as an optimized subprompt for the respective subtask.

In Example 29, the subject matter of Example 28 optionally includes wherein to measure the semantic variance includes producing a semantic variance score from an evaluation of at least one of: a n-gram similarity that measures similarity between n-grams of two outputs; cosine similarity that measures similarity between two embeddings; or a Jaccard index that measures similarity between terms, n-grams, or features of two sets; and wherein measuring the accuracy includes producing a semantic precision score of a corresponding evaluation result, and wherein measuring the coherency includes producing a coherence score of the corresponding evaluation result.

In Example 30, the subject matter of Example 29 optionally includes wherein the reinforcement learning reward is produced from a loss function that uses the semantic variance score, the semantic precision score, and the coherence score for each respective candidate subprompt, and wherein gradient descent is applied to iteratively refine each respective candidate subprompt to target loss minimization.

Example 31 is at least one machine-readable medium (e.g., a non-transitory computer-readable storage medium) including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

What is claimed is:

1. A method for automated language model prompt optimization, comprising:
receiving a base prompt for an overall task to be performed with a language model;
based on the base prompt, deriving task instructions for the language model to perform the overall task;
based on the task instructions, forming multiple different combinations of subtasks, wherein each of the different combinations of subtasks provides a different number of subtasks that, if performed collectively, accomplish the overall task;
for each of the different combinations of subtasks, generating a corresponding combination of subprompts that, if performed by the language model, collectively accomplish that combination of subtasks;
for each of the different combinations of subtasks, producing a performance prediction of that combination to accomplish the overall task using the language model, according to the corresponding combination of the subprompts;
evaluating the performance prediction of each of the different combinations of subtasks against a threshold performance condition;
selecting one combination from the different combinations of subtasks for performing the overall task, wherein the selected combination has a performance prediction meeting the threshold performance condition, and has a lowest number of subtasks among all combinations having respective performance predictions meeting the threshold performance condition;
executing the subprompts corresponding to the selected combination of subtasks using the language model and data associated with the base prompt, to accomplish the overall task; and
outputting a response to the base prompt based on a result of the executing of the subprompts.

2. The method of claim 1, wherein the method includes serially generating additional different combinations of subtasks, generating subprompts used by the additional different combinations of subtasks, and evaluating a performance prediction of the additional different combinations of subtasks, until the threshold performance condition is met.

3. The method of claim 1, wherein the method includes generating additional different combinations of subtasks, generating subprompts used by the additional different combinations of subtasks, and evaluating a performance prediction of the additional different combinations of subtasks, in parallel for the different number of subtasks, wherein a number of subtasks is changed until the threshold performance condition is met.

4. The method of claim 1, wherein the threshold performance condition is based on a prediction of execution time, cost, or performance, and wherein the prediction is produced from evaluating the subprompts for the different combinations of subtasks with a learned model.

5. The method of claim 1, wherein the threshold performance condition is based on accuracy or coherence of results produced from the subprompts for the different combinations of subtasks, and wherein the results are produced from trial runs that execute the subprompts on sample data.

6. The method of claim 5, further comprising:
generating the sample data, wherein the sample data is associated with the overall task;
wherein the language model is a large language model (LLM), the method is repeated with use in a plurality of LLMs, and performance of the subprompts is compared based on use in the plurality of LLMs.

7. The method of claim 1, wherein generating the corresponding combination of the subprompts includes iteratively generating optimized subprompts that accomplish the different combinations of subtasks, using a reinforcement learning technique, to improve and produce subprompts used by each of the combinations of subprompts.

8. The method of claim 7, wherein iteratively generating the optimized subprompts includes, for a respective subtask of the different combinations of subtasks:
generating multiple different candidate subprompts for the respective subtask, wherein each candidate subprompt includes varying subtask instructions to control the language model to perform the respective subtask;
executing the multiple different candidate subprompts in the language model to generate corresponding multiple evaluation results for the respective subtask;
measuring semantic variance, accuracy, and coherence of the multiple evaluation results using at least one natural language processing technique;
determining a reinforcement learning reward for each candidate subprompt of the multiple different candidate subprompts, based on the semantic variance, accuracy, and coherency measured for a respective result produced from the candidate subprompt;
refining the multiple different candidate subprompts based on the reinforcement learning reward determined for each candidate subprompt; and
selecting one of the multiple different candidate subprompts as an optimized subprompt for the respective subtask.

9. The method of claim 8, wherein measuring the semantic variance includes producing a semantic variance score from an evaluation of at least one of:
a n-gram similarity that measures similarity between n-grams of two outputs;
cosine similarity that measures similarity between two embeddings; or
a Jaccard index that measures similarity between terms, n-grams, or features of two sets; and
wherein measuring the accuracy includes producing a semantic precision score of a corresponding evaluation result, and wherein measuring the coherency includes producing a coherence score of the corresponding evaluation result.

10. The method of claim 9, wherein the reinforcement learning reward is produced from a loss function that uses the semantic variance score, the semantic precision score, and the coherence score for each respective candidate subprompt, and wherein gradient descent is applied to iteratively refine each respective candidate subprompt to target loss minimization.

11. A non-transitory machine-readable medium, storing instructions for automated language model prompt optimization, the instructions, which when executed, cause a machine to perform operations comprising:
receiving a base prompt for an overall task to be performed with a language model;
based on the base prompt, deriving task instructions for the language model to perform the overall task;
based on the task instructions, forming multiple different combinations of subtasks, wherein each of the different combinations of subtasks provides a different number of subtasks that if performed collectively, accomplish the overall task;
for each of the different combinations of subtasks, generating a corresponding combination of subprompts that, if performed by the language model, collectively accomplish that combination of subtasks;
for each of the different combinations of subtasks, producing a performance prediction of that combination to accomplish the overall task using the language model, according to the corresponding combination of the subprompts;
evaluating the performance prediction of each of the different combinations of subtasks against a threshold performance condition;
selecting one combination from the different combinations of subtasks for performing the overall task, wherein the selected combination has a performance prediction meeting the threshold performance condition, and has a lowest number of subtasks among all combinations having respective performance predictions meeting the threshold performance condition;
executing the subprompts corresponding to the selected combination of subtasks using the language model and data associated with the base prompt, to accomplish the overall task; and
outputting a response to the base prompt based on a result of the executing of the subprompts.

12. The non-transitory machine-readable medium of claim 11, wherein the operations comprise serially generating additional different combinations of subtasks, generating subprompts used by the additional different combinations of subtasks, and evaluating a performance prediction of the additional different combinations of subtasks, until the threshold performance condition is met.

13. The non-transitory machine-readable medium of claim 11, wherein the operations comprise generating additional different combinations of subtasks, generating subprompts used by the additional different combinations of subtasks, and evaluating a performance prediction of the additional different combinations of subtasks, in parallel for the different number of subtasks, wherein a number of subtasks is changed until the threshold performance condition is met.

14. The non-transitory machine-readable medium of claim 11, wherein the threshold performance condition is based on a prediction of execution time, cost, or performance, and wherein the prediction is produced from evaluating the subprompts for the different combinations of subtasks with a learned model.

15. The non-transitory machine-readable medium of claim 11, wherein the threshold performance condition is based on accuracy or coherence of results produced from the subprompts for the different combinations of subtasks, and wherein the results are produced from trial runs that execute the subprompts on sample data.

16. The non-transitory machine-readable medium of claim 15, the operations further comprising:
generating the sample data, wherein the sample data is associated with the overall task;
wherein the language model is a large language model (LLM), the operations are repeated with use in a plurality of LLMs, and performance of the subprompts is compared based on use in the plurality of LLMs.

17. The non-transitory machine-readable medium of claim 11, wherein generating the corresponding combination of the subprompts includes iteratively generating optimized subprompts that accomplish the different combinations of subtasks, using a reinforcement learning technique, to improve and produce subprompts used by each of the combinations of subprompts.

18. The non-transitory machine-readable medium of claim 17, wherein iteratively generating the optimized subprompts includes, for a respective subtask of the different combinations of subtasks:
generating multiple different candidate subprompts for the respective subtask, wherein each candidate subprompt includes varying subtask instructions to control the language model to perform the respective subtask;
executing the multiple different candidate subprompts in the language model to generate corresponding multiple evaluation results for the respective subtask;
measuring semantic variance, accuracy, and coherence of the multiple evaluation results using at least one natural language processing technique;
determining a reinforcement learning reward for each candidate subprompt of the multiple different candidate subprompts, based on the semantic variance, accuracy, and coherency measured for a respective result produced from the candidate subprompt;
refining the multiple different candidate subprompts based on the reinforcement learning reward determined for each candidate subprompt; and
selecting one of the multiple different candidate subprompts as an optimized subprompt for the respective subtask.

19. The non-transitory machine-readable medium of claim 18, wherein measuring the semantic variance includes producing a semantic variance score from an evaluation of at least one of:
a n-gram similarity that measures similarity between n-grams of two outputs;
cosine similarity that measures similarity between two embeddings; or
a Jaccard index that measures similarity between terms, n-grams, or features of two sets; and
wherein measuring the accuracy includes producing a semantic precision score of a corresponding evaluation result, and wherein measuring the coherency includes producing a coherence score of the corresponding evaluation result.

20. The non-transitory machine-readable medium of claim 19, wherein the reinforcement learning reward is produced from a loss function that uses the semantic variance score, the semantic precision score, and the coherence score for each respective candidate subprompt, and wherein gradient descent is applied to iteratively refine each respective candidate subprompt to target loss minimization.
